(19) United States
(12) Patent Application Publication
(10) Pub. No.: US 2026/0139939 A1
(43) Pub. Date: May 21, 2026

(54) POSITION SENSOR ASSEMBLY

(71) Applicant: KSR IP Holdings, LLC, Wilmington, DE (US)

(72) Inventor: Joong Lee, Toronto (CA)

(73) Assignee: KSR IP Holdings, LLC, Wilmington, DE (US)

(21) Appl. No.: 19/393,881

(22) Filed: Nov. 19, 2025

Related U.S. Application Data
(60) Provisional application No. 63/722,929, filed on Nov. 20, 2024.

(51) Int. Cl. G01B 7/30; G01D 5/243; G01P 3/48; H02P 21/00; H02P 21/18

(52) U.S. Cl. CPC G01B 7/30; G01D 5/243; G01P 3/4802; H02P 21/0085; H02P 21/18

(57) ABSTRACT

Embodiments described herein are directed to a position sensor that includes a first receiver coil electrically coupled to a first multiplier to generate a first output, a second receiver coil electrically coupled to a second multiplier to generate a second output, a transmitter coil electrically coupled to an oscillator, the oscillator electrically coupled to a third multiplier to generate a third output, a phase-locked loop electrically coupled to the oscillator and the transmitter coil, a summing circuit configured to receive the first output and the second output and configured to generate a signal, a phase detector configured to receive the signal and the third output, the phase detector outputting a sense signal that is indicative of an angle of the motor position sensor, and a pair of op amps electrically coupled to the phase detector. The op amps configured to output an analog differential signal and a differential phase signal.

### CROSS-REFERENCE TO RELATED APPLICATIONS

This application claims priority to U.S. Provisional Patent Application Ser. No. 63/722,929, filed on Nov. 20, 2024, the entire contents of which is herein incorporated by reference in its entirety.

### TECHNICAL FIELD

The present specification generally relates to an assembly for position sensing and, more specifically, to an assembly for rotary or motor position sensing in both low and high speed applications.

### BACKGROUND

Modern electric vehicles rely on electrical drives that have a high power density and require high efficiency due to reliance on battery-based energy storage system. Those high-power density drives are configured for high speed applications for mobility in applications that require light weight. The same situation can be applied to drones and humanoids. But the high power density alone is not enough for the high efficiency needs and accuracy control that are required for modern applications mentioned above. Traditionally, high speed control has been developed in the Variable Frequency Drives (“VFDs”) or Variable Voltage Variable Frequency inverters (“VVVF”) associated with variable frequency inverters to apply speed and torque control. However, hardware-based control methods of VFDs or VVVF inverters are insufficient for achieving the high efficiency and accuracy controls that modern applications require, mentioned above. Therefore, modern control for speed and torque control requires better strategy to achieve the efficiency and accuracy of the motor for eventually better performance and saving battery power.

Modern control strategies for speed and torque include field oriented control (“FOC”), direct torque and frequency control (“DTFC”), state variable method (“SVM”), and the like. Each of these control strategies require a high-speed motor position sensor in order to obtain high efficiency. But modern-day motor position sensors are implemented as resolvers, optic, or magnetic encoders, which are expensive and obtain additional motor position information separately. For example, the resolvers have quadrature output (sine and cosine) that should be decoded by high-speed digital signal processor (“DSP”) or resolver to digital converter (“RDC”). Other encoders have their own limitations, such as contamination with optic encoders and high magnetic fluctuations around magnetic sensor arrays for magnetic encoder, and/or the like. Therefore, the shielding schemes against them are costly and do not fit into light and compact nature of the application that have required high power density motor drives.

Further still, slow speed sensing is needed. For example, most modern automotive vehicles include a traditional electronic throttle control (“ETC”) sensor on internal combustion engines and/or a throttle position sensor which detects the rotational position of the throttle plate and generates an electrical output signal representative of that position. That electrical signal is then electrically connected to an engine management unit which controls the overall operation of the internal combustion engine for the vehicle as a function of the position or depression of the throttle. Consequently, modern day sensors should cover a wide range of speed of motor position from slow ETC actuators to high-speed motors.

### SUMMARY

In one embodiment, a motor position sensor is provided. The motor position sensor includes a first receiver coil electrically coupled to a first multiplier to generate a first output, a second receiver coil electrically coupled to a second multiplier to generate a second output, and a transmitter coil electrically coupled to an oscillator, the oscillator electrically coupled to a third multiplier to generate a third output. Further, the motor position sensor includes a phase-locked loop electrically coupled to the oscillator and the transmitter coil, a summing circuit configured to receive the first output and the second output and configured to generate a signal, a phase detector positioned in series with the summing circuit and configured to receive the signal and the third output, the phase detector outputting a sense signal that is indicative of an angle of the motor position sensor, and a pair of op amps electrically coupled to the phase detector. One operational amplifier (op amp) of the pair of op amps configured to output an analog differential signal and the other one op amp of the pair of amp amps configured to output a differential phase signal.

In another embodiment, a rotary position sensor is provided. The rotary position sensor includes a first receiver coil electrically coupled to a first multiplier to generate a first output, a second receiver coil electrically coupled to a second multiplier to generate a second output, a transmitter coil electrically coupled to an oscillator, the oscillator electrically coupled to a third multiplier to generate a third output, a phase-locked loop electrically coupled to the oscillator and the transmitter coil, and a summing circuit configured to receive the first output and the second output and configured to generate a signal. The rotary position sensor further includes a phase detector positioned in series with the summing circuit and configured to receive the signal and the third output, the phase detector outputting a sense signal that is indicative of an angle of the motor position sensor, a counter configured to receive the sense signal and output, based on the sense signal, a speed of counter signal, and a pair of op amps electrically coupled to the phase detector. One op amp of the pair of op amps configured to output an analog differential signal and the other one op amp of the pair of amp amps configured to output a differential phase signal. The output of the analog differential signal and the output of the differential phase signal defines a ratio of two channel amplitudes.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a circuit architecture for an example position sensor assembly according to one or more embodiments shown and described herein;

FIG. 2 schematically depicts a first example circuit architecture for a conventional position sensor assembly;

FIG. 3 schematically depicts a second example circuit architecture for a conventional position sensor assembly;

FIG. 4 schematically depicts a circuit architecture for a conventional phase detector circuit of the first example conventional position sensor assembly of FIG. 2 or of the second example conventional position sensor assembly of FIG. 3;

FIG. 5 schematically depicts an isolated view of an angle encoder of the example position sensor assembly of FIG. 1 according to one or more embodiments shown and described herein;

FIG. 6A schematically depicts a circuit diagram of a direction sensitive phase detector of the example position sensor assembly of FIG. 1 according to one or more embodiments shown and described herein;

FIG. 6B graphical illustrates an output of the direction sensitive phase detector of FIG. 6A which illustrates sign changes when the phase goes negative according to one or more embodiments shown and described herein;

FIG. 7A schematically depicts a circuit architecture for an embodiment of the example position sensor assembly of FIG. 1 that includes of a radio frequency (RF) to base band implementation as a signal flow in and the details of mixing function according to one or more embodiments shown and described herein;

FIG. 7B schematically depicts a circuit architecture for an in-phase channel in mixed signals diagram of the example position sensor assembly 10 of FIG. 7A according to one or more embodiments shown and described herein;

FIG. 8, which schematically depicts a circuit architecture for an output frequency equal to a local oscillator that translates RF input signal down to lower center frequency for base band management of FIG. 7A according to one or more embodiments shown and described herein;

FIG. 9 schematically depicts a circuit architecture for an implementation of a n-fractional PLL of FIG. 8 according to one or more embodiments shown and described herein;

FIG. 10A schematically depicts a circuit architecture for a second implementation of a n-fractional PLL of FIG. 8 without the counter according to one or more embodiments shown and described herein;

FIG. 10B schematically depicts a dual-modulus prescaler circuit architecture of the second implementation of a n-fractional PLL of FIG. 10A according to one or more embodiments shown and described herein;

FIG. 11 schematically depicts an example quadrature oscillator implantation circuit architecture according to one or more embodiments shown and described herein;

FIG. 12 graphically depicts one embodiment for a solution to a zero duty problem with limited ramping according to one or more embodiments shown and described herein; and

FIG. 13 graphically depicts one embodiment for solutions to backlash problems according to one or more embodiments shown and described herein.

### DETAILED DESCRIPTION

Embodiments herein are directed to a position sensor assembly for not only detecting a position of a target, but also providing data with respect to a direct output of angle and a speed of a rotor of a motor. In other words, the example position sensor assembly described herein produces desirable data that is not possible with conventional sensor assembly, and does so with a smaller form factor and less power consumption compared to conventional position sensor assemblies. Said another way, the example position sensor assemblies described herein directly output both an angle and a speed, and do so using smaller form factors and less power consumption.

Further, the example position sensor assembly described herein may be used in both low speed and high speed applications. As such, the example position sensor assembly described herein is configured to meet current technical desires of high power density, high efficiency requirements, high speed data transmission, and reduction of magnetic noise and environmental contaminations. The example position sensor assembly described herein is configured to encode angles in amplitude modulation in a form of pulse width modulation (PWM), from which the example position sensor assembly described herein converts the encoded angles to represent a digital position and speed by implementing a high speed counter. This conversion can be performed without digitizing the encoded angles again. This is done completely in single architecture without external DSP or RDC support.

As used herein, the term “electrically coupled” means that coupled components are capable of exchanging data signals and/or electric signals with one another such as, for example, electrical signals via conductive medium, electromagnetic signals via air, optical signals via optical waveguides, electrical energy via conductive medium or a non-conductive medium, data signals wirelessly and/or via conductive medium or a non-conductive medium, and the like as understood by those having skill in the art.

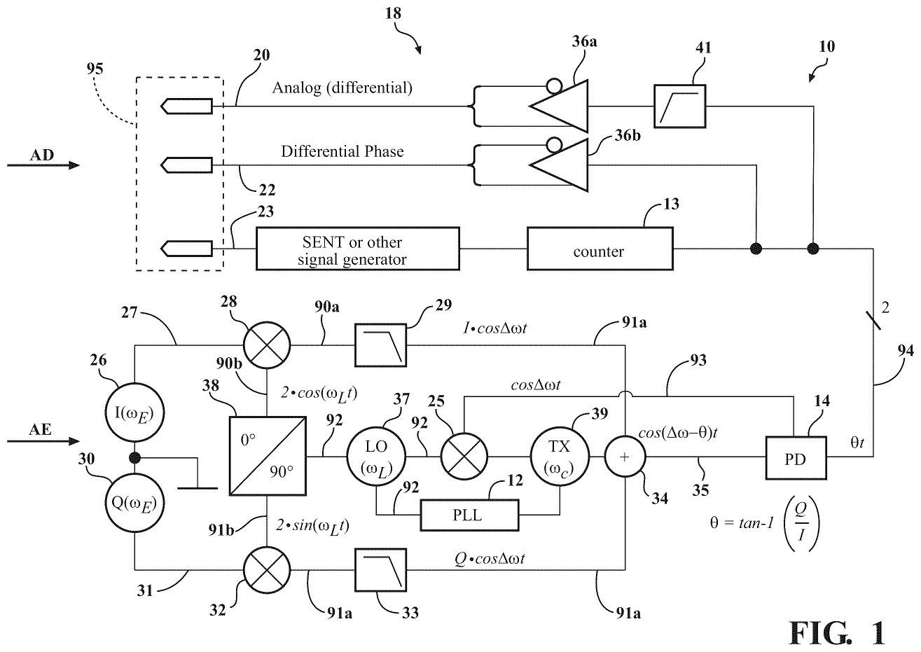

Now referring to FIG. 1, a circuit architecture for an example position sensor assembly 10 is schematically depicted. The example position sensor assembly 10 may be a motor position sensor and/or a rotatory position sensor for a wide adaptation of various speeds by utilizing a phase-locked loop (“PLL”) 12. In some embodiments, the PLL 12 may be a fractional PLL (fPLL). The fPLL may be configured as a single PLL or as two PLLs that can be utilized for independent applications. When configured individually, the fPLL is configured in conventional integer mode, which is equivalent to a general purpose PLL (GPLL). When configured as two PLLs, the output counters are shared between both PLLs in the block, and the fPLL is configured in enhanced fractional mode with third-order delta-sigma modulation. It should be understood that fPLLs synthesize multiple clock frequencies from a single reference clock source. Therefore, implementation of fPLLs requires fewer oscillators to be used on a printed circuit board (“PCB”). Implementation of fPLLs also require fewer clock pins to be used in a field programmable gate array (FPGA) or integrated circuit (“IC”).

In addition, it should be understood that fPLLs may be used for clock network delay compensation, zero-delay buffering, and transmit clocking for transceivers. As such, the PLL 12 (which may be fPLLs, gPLLs, integers, and/or the like) described herein may be configured to determine a resolution and a speed of a counter 13, which replaces a slow and complex delta-sigma modulator found in conventional sensor assemblies, as discussed in greater detail herein. Further, the speed adaptation may be from an Electrically Erasable Programmable Read-Only Memory (“EEPROM,”) and a tank resonant frequency setting, resulting in a speed adaptation that is much easier compared to conventional motor sensors. It should be appreciated that in some embodiments, a “tank resonant frequency” may refer to the specific frequency at which a tank circuit (a parallel combination of an inductor and capacitor) oscillates most efficiently, and is determined by the values of the inductance (L) and capacitance (C) in the circuit, calculated using the formula: f=1/(2π√(LC)), meaning to adjust the resonant frequency, either the inductor or capacitor values within the circuit need to be changed.

As such, this controllability allows the example position sensor assembly 10 described herein to be utilized in a wide range of applications, such as, and without limitation, both high-speed and low speed applications in pedal assemblies, robotics, actuators, gas compressor motor position sensing, rotors for motors, and/or the like.

Still referring to FIG. 1, an in-phase signal I of angular frequency 27 generated from a first receiver coil 26 is electrically coupled as an input to a multiplier 28 and a quadrature signal Q t of angular frequency 31 generated from a second receiver coil 30 is electrically coupled as an input to a multiplier 32. Furthermore, the generated output signals from multipliers 28 and 32 (e.g., first output signal 90a and second output signal 91a, respectively) may, in some embodiments, pass through a low-pass filter 29 and a low-pass filter 33, respectively, to form quadrature signals ready for summation by a summing circuit 34. The first output signal (“FOS”) 90a may be an in-phase signal defined by the Equation 1:

$$FOS = I ( cos Δω t ) \qquad Equation 1$$

where I is an amplitude of an in-phase component (signal is in phase (0 degrees) with a reference carrier), cos is the cosine function, and Δωt is a phase angle (the angle of oscillation at time t, which changes as t increases).

The second output signal (“SOS”) 91a may be quadrature signal defined by the Equation 2:

$$SOS = Q ( cos Δω t ) \qquad Equation 2$$

where Q is an amplitude of the quadrature component (signal is 90 degrees out of phase with the reference carrier), cos is the cosine function, and Δωt is a phase angle (the angle of oscillation at time t, which changes as t increases).

Each of the multipliers 28, 32 are electrically coupled to a frequency multiplier 38. Multiplier 28 outputs a first frequency signal 90b. Multiplier 32 outputs a second frequency signal 91b. First frequency signal 90b and second frequency signal 91b are provided to the frequency multiplier 38. The first frequency signal (“FFS”) 90b is defined by Equation 3:

$$FFS = 2 cos ( {ω}_{L} t ) \qquad Equation 3$$

where 2 is the amplitude scaling factor, cos is the cosine function, ω_{L} is an angular frequency of the oscillation, and t is the time.

The second frequency signal 91b (“SFS”) is defined by Equation 4:

$$SFS = 2 sin ( {ω}_{L} t ) \qquad Equation 4$$

where 2 is the amplitude scaling factor, sin is the sine function, ω_{L} is an angular frequency of the oscillation, and t is the time. The frequency multiplier 38 is electrically coupled to the multipliers 28, 32. The angular frequency received may be offset (e.g., by 90 degrees) based on the electronic coupling between frequency multiplier 38 and multipliers 28, 32. Further, the frequency multiplier 38 is electrically coupled to a local oscillator 37. An output 92 of the local oscillator 37 is received by one or more of the frequency multiplier 38, the multiplier 25 or the PLL 12.

Still referring to FIG. 1, the output signals from these multipliers 28, 32 (e.g., first output signal 90a, second output signal 91a, respectively) that may or may not pass though low-pass filters 29, 33, respectively, are received by the summing circuit 34 to generate a summed signal (“SS”) 35. The summed signal 35 is defined by Equation 5:

$$SS = cos ( Δω - θ ) t \qquad Equation 5$$

where cos is the cosine function, Δω is the difference between two angular frequencies (e.g., the first output signal 90a and the second output signal 91a), θ is an angle or a phase shift affecting the overall oscillation, and t is time, and in some embodiments, may be a phase constant. As such, in some embodiments, the frequency modulation (FM) or phase modulation (PM) is altered by the signals received by the receiver coils 26, 30, respectively.

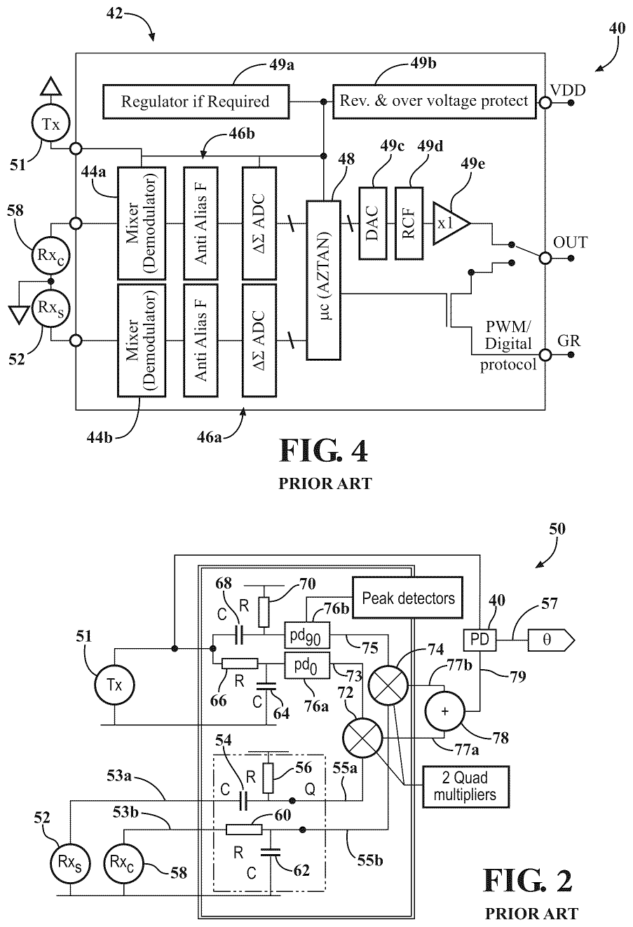

The summed signal 35 is received as a first input by a phase detector 14. In the example position sensor assembly 10, the phase detector 14 replaces power demanding devices in conventional circuit/sensor assemblies, described below with respect to at least FIG. 2 (e.g., the pairs of mixers, delta-sigma modulators, and a microcontroller). As such, the example position sensor assembly 10 includes a minimal digital back end for the WU motor outputs to be implemented, which also generates an automatic generator control (“AGC”) control and transfer function for utilization for other components, such as sensing applications used in pedal assemblies, sensing applications used in robotics, gas compressor motor position sensing, actuators, rotors, and/or the like. It should be appreciated that the phase detector 14 may be configured to measure a phase shift between two signals of the same frequency to produce a series of output pulses whose width is proportional to the phase difference. Further, it should be appreciated that the transfer function may refer to transformation of a time-domain signal to a phasor domain for sinusoidal signals.

Other inputs into the phase detector 14 may include a third output signal (“TOS”) 93 generated by the multiplier 25 that is electrically coupled to the phase detector 14, the local oscillator 37, and the transmitter coil 39. The summed signal 35 is defined by Equation 6:

$$TOS = cos Δω t \qquad Equation 6$$

where cos is the cosine function, Δω is the change in angular frequency, and t is time.

The local oscillator 37 is also in electrically coupled with the PLL 12 and the frequency multiplier 38. The frequency multiplier 38 is electrically coupled to the multipliers 28, 32 such that the angular frequency received is 90 degree offset. The transmitter coil 39 is electrically coupled to the PLL 12. The phase detector 14 generates and outputs a sense signal 94. The sense signal 94 is defined by Ot, which is indicative of an angle of the example position sensor assembly 10. The sense signal 94 is received by the counter 13 and is separated into a pair of operational amplifiers (op-amps) 36a, 36b to generate an output 18. A high-pass filter 41 may be positioned in series with the phase detector 14 and the op-amp 36a.

Each of the op-amps 36a, 36b may be a high-gain voltage amplifier integrated circuit with differential inputs and a single-ended output. For example, each of the op-amps 36a, 36b amplifies the difference between its two inputs (e.g., the sense signal 94) to output a function of the ratio of two channels of information—an analog differential value 20 and a differential phase value 22.

The phase detector 14 is in electrical series with, and electrically coupled to, both of the multipliers 28, 32 through the summing circuit 34 to generate an almost DC signal so that the first and second output signals 90a, 91a of the multipliers 28, 32, respectively, can maintain the main frequency ω. As discussed above, the first and second outputs 90a, 91a from the two multipliers 28, 32, respectively, form quadrature signals and the first and second outputs 90a, 91a from the two multipliers 28, 32 are summed together at the summing circuit 34. As such, the summed signal 35 output from the summing circuit 34 is equal to cos(Δω+θ)t where θ equals the angle of the position sensor. As such, the above-described architecture denoted by arrow AE in FIG. 1 may be an angle encoder. That is, the above-described architecture denoted by arrow AE in FIG. 1 may be a versatile sensor that can be used in both low speed and high speed motor applications without a DSP, RDC, or the like, such as those required in conventional systems.

It should be appreciated that the phase detector 14 enables phase detecting and encoding for high speed signal decoder by a PWM, which are effectively AM modulation for simple conversion to analog or digital format.

Further, as illustrated in FIG. 1, the output 18 of the example position sensor assembly 10 is a function of the ratio of two channels of information—the analog differential value 20 and the differential phase value 22 and includes a third output 23 generated by the counter 13. That is, the output 18 is angle using the arctangent (“ATAN”) of the ratio of two channel-amplitudes 20, 22 as shown in Equation 7 below:

$$θ = {tan}^{- 1} ( \frac{Q}{I} ) \qquad Equation 7$$

Therefore, the output 18 does not change for temperature and other common mode influence like electromagnetic capability (EMC). As such, as the ratio remains the same, the output 18 stays the same. The set of outputs illustrated in FIG. 1 are shown, where traditional delta-sigma modulation is replaced with the counter 13, which is simple and has negligible delay across it. As such, the outputs 18, 23 are compressed into a single angle phase signal, which are output as outputs 20, 22, 23 by the angle decoder denoted by arrow AD in FIG. 1, as an angle decoder signal into a processor 95, microcontroller, electronic control unit, and/or the like. The processor 95 may be configured to be on the same printed circuit board as the example position sensor assembly 10 or positioned separately or remote form the other components of the example position sensor assembly 10.

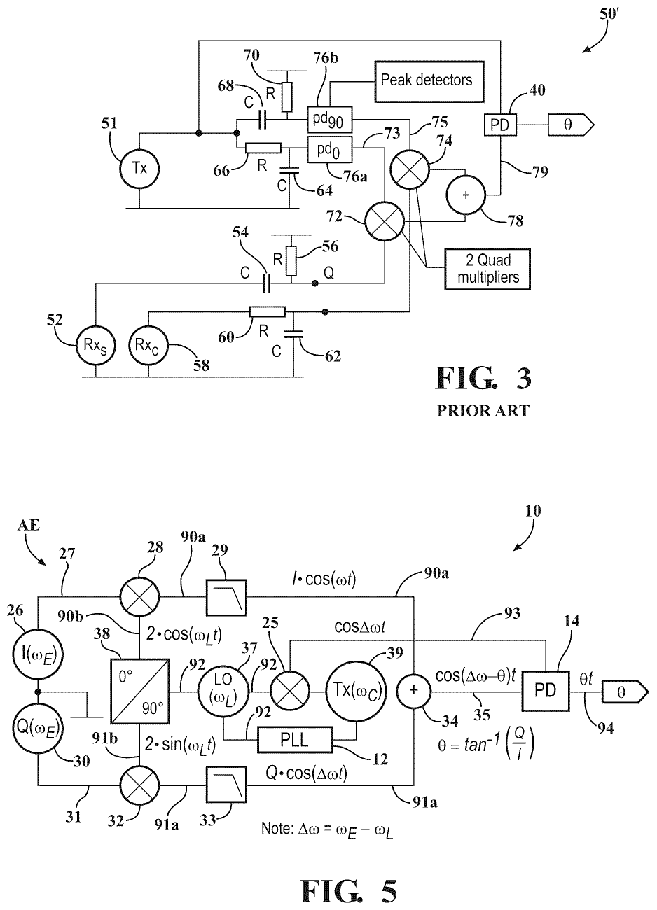

For illustrative purposes only, now referring to FIGS. 2-3, which depicts a first conventional position sensor assembly 50 and a second conventional position sensor assembly 50′. Each of the conventional position sensor assembly 50 and a second conventional position sensor assembly 50′ include a transmitter coil 51, a first receiver coil 52, and a second receiver coil 58. The conventional position sensor assemblies 50, 50′ include a voltage signal 53a from the first receiver coil 52 coupled as an input signal to a capacitor 54 and resistor 56 to define a low-pass filter. Similarly, a voltage signal 53b from the second receiver coil 58 is coupled as an input signal to a resistor 60 and capacitor 62 to define another low-pass filter. Furthermore, output signals 55a, 55b, respectively, from these two form quadrature signals are ready for summation to generate the signal (θ) 57. However, each output signal 55a, 55b of the quadrature signal pair has magnitude deviation due to both temperature and frequency because of impedance of capacitor and resistor varies with temperature and frequency.

To remedy this, a temperature and frequency compensation is implemented using a capacitor 64 and resistor 66 and a capacitor 68 and resistor 70, respectively. Specifically, an output from an oscillator passes through the two branch outputs 55a, 55b to have different temperature and frequency impacts. When the output Q is multiplied by a multiplier 72 with an output 73, then the output of the multiplier 72 has the same characteristics as an output of a multiplier 74 which multiplies outputs of the other output 75, respectively, thus providing automatic temperature compensation.

In order to facilitate multiplication, peak detectors 76a, 76b are connected in series between the multipliers 72, 74, respectively, which generate an almost DC signal so that the output 73, 75 of multipliers 72, 74, respectively, can maintain the main frequency ω. Peak detector may refer to a series connection of a diode and a capacitor outputting a DC voltage equal to the peak value of the applied AC signal.

The outputs 73, 75 from the two multipliers 72, 74, respectively, form quadrature signals and outputs 77a, 77b, from the two quadrature multipliers 72, 74, respectively, are summed together at a summing circuit 78. Consequently, an output 79 from the summing circuit 78 is equal to −cos(ωt+θ) where θ equals the angle of the position sensor. The output 79 is then processed through the conventional phase detector circuit 40, similar to that described in FIG. 4.

Now referring to FIG. 4, a circuit architecture for a conventional phase detector circuit 40 of a conventional circuit such as the conventional position sensor assemblies 50, 50′ illustrated in FIGS. 2-3 is schematically depicted. As illustrated, in the conventional phase detector circuit 40, the phase detecting sensor 42 requires pairs of mixers 44a, 44b, delta-sigma modulators 46a, 46b, and a microcontroller 48 for calculation of two signals using ATAN, which are slow and power demanding devices and hence other applications cannot be implemented into, without limitation, WU motor outputs from the motor. Further, the conventional phase detector circuit 40 may also require or need a regulator device 49a, a reverse plurality and over voltage protection device 49b, a digital to analog converter 49c, a resistance-capacitance filter (RCF) 49d, a gain block or amplifier 49e, and the like. The conventional phase detector circuit 40 is electrically coupled to the transmitter coil 51, the first receiver coil 52, and the second receiver coil 58 of the conventional position sensor assemblies 50, 50′.

It should be understood that the example position sensor assembly 10 discussed herein and illustrated in FIG. 1, when compared to conventional position sensor assemblies 50, 50′ (FIGS. 2-4), has a faster booting cycle resulting in a small or less booting time compared to conventional position sensors, and uses very low duty when measuring a ratio-metric angle of the motor so that the example position sensor assembly 10 is seamlessly integrated WU into angle measure. That is, the example position sensor assembly 10 described herein compared to conventional position sensor assemblies 50, 50′, such as those described with respect to FIGS. 2-4, with respect to speed for angle measurement, the example position sensor assembly 10 is high speed due to a native angle measure by PWM output whereas the conventional position sensor assemblies 50, 50′ of FIGS. 2-4 are slow speed and require external coil for compensation. As such, the example position sensor assembly 10 has a planar resolver application for high speed motor position based on analog quadrature signal output of a conventional sensor assembly.

As such, it should now be understood that, with respect to the speed control, the example position sensor assembly 10 utilizes the transmitter coil 39 resonating frequency at a counter speed whereas conventional sensor assemblies 50, 50′ utilizes the transmitter coil 51 resonating frequency at a sampling speed. Therefore, the example position sensor assembly 10 has a sampling speed at a Nyquist rate (e.g., a sampling frequency that is exactly twice the highest frequency component in the signal denoted as fs=2fmax), whereas the conventional position sensor assemblies 50, 50′ have a delta-sigma structure that limits speed. Additionally, with respect to resolution, the example position sensor assembly 10 is based on the speed of the counter 13 whereas the conventional position sensor assemblies 50, 50′ are based on an integrator size. Lastly, the example position sensor assembly 10 may be used in slow speed to very high speed applications whereas the conventional position sensor assemblies 50, 50′ are slow and can only be used in high speed applications.

Now referring to FIG. 5, an isolated view of the angle encoder portion of the example position sensor assembly 10 of FIG. 1 is schematically depicted. As depicted in FIG. 5, in the example position sensor assembly 10, the PLL 12 controls the speed of the PWM, which permits for both low-speed and high-speed solutions. That is, the speed adapts through PLL 12, which may be a fPLL for improved control of center frequency of PWM output compared to the conventional position sensor assemblies 50 illustrated and discussed with respect to FIGS. 3-4.

That is, the example position sensor assembly 10 described herein compared to the conventional position sensor assemblies 50, 50′ (FIGS. 2-4), with respect to a speed adaptation, the example position sensor assembly 10 utilizes a transmitter coil frequency and PLL (N-1)/N fractional, whereas the conventional position sensor assemblies 50, 50′ (FIGS. 2-4) merely utilize the a transmitter coil frequency by an inductor and capacitor arrangement. As such, the example position sensor assembly 10 described herein uses EEPROM for PLL configuration settings, such as frequency plans and other parameters. With respect to resolution control on the digital output, the example position sensor assembly 10 described herein is configured to be based on the speed of the counter PLL, whereas the conventional position sensor assemblies 50 (FIGS. 2-4) merely utilize the speed of counter. As such, the example position sensor assembly 10 described herein uses a resolution control by the EEPROM, which is more flexible and enables a broader range of resolution control. Both the example position sensor assembly 10 described herein and the conventional position sensor assemblies 50, 50′ (FIGS. 2-4) are not limited by counter speed with respect to the resolution on the analog output, meaning that there is not a need of high-speed counter on either of the example position sensor assembly 10 described herein and the conventional position sensor assemblies 50, 50′ (FIGS. 2-4). As such, the example position sensor assembly 10 described herein can be used in both slow applications and in high speed applications by simple control and/or adjustment, whereas the conventional position sensor assemblies 50, 50′ (FIGS. 2-4) can only be used in high speed applications. Therefore, the example position sensor assembly 10 described herein can be used in electronic throttle control applications to gas compressor motor control. Therefore, the example position sensor assembly 10 described herein provides extreme flexibility in application and use.

Said another way, the example position sensor assembly 10 described herein provides for implantation in a wide range of speeds such as, and without limitation, from electronic controlled controller (ETC) applications to motor application for Field-Oriented Control (FOC) at 20,000 RPM with a 4,000 CPR encoder (or 100 k RPM with 1000 CPR for gas compressor). As such, the example position sensor assembly 10 described herein is configured to have a speed high enough for the following:

### Calculating the Required Sampling Frequency for High-Speed Motor

Motor Speed: 20,000 RPM translates to approximately 333.33 revolutions per second (RPS).
Encoder Pulses: With a 4,000 CPR encoder (or 100 k RPM with 1000 CPR for gas compressor), this results in 1,333,320 pulses per second (333.33 RPS*4,000 CPR).

### Sampling Frequency

Nyquist Criterion: According to the Nyquist criterion, the sampling frequency should be at least twice the signal frequency to accurately capture the data. Therefore, the minimum sampling frequency should be:
   1. Minimum sampling frequency=2×1,333,320=2.67 Mhz
   2. Up to 4 MHz operation frequency.

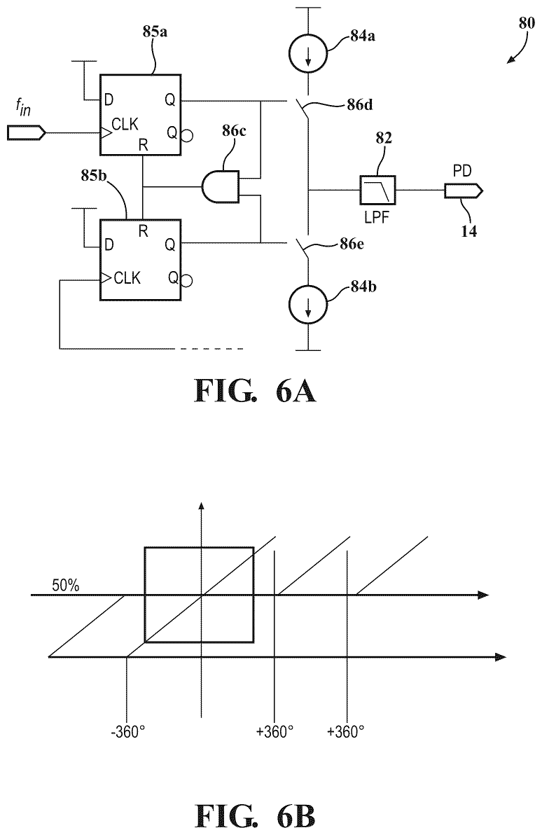

Now referring to FIG. 6A, in some embodiments, the example position sensor assembly 10 of FIG. 1 may be based on and/or include a direction sensitive phase detector 80, which shows the sign changes when the phase goes negative. The phase detector 14 for PLL 12 and sensor output are identical, but the time constant of low-pass filters (LPFs) 82 are different, and the current sources 84a, 84b have different current source magnitude. As such, the direction sensitive phase detector 80 is a precision phase detector. As depicted, the direction sensitive phase detector 80 may include a pair of clocked flip-flop circuits 85a, 85b. In the depicted embodiment, each of the pair of clocked flip-flop circuits 85a, 85b is a D-type flip-flop in which the D may be a data input, and may be configured such that if the data input is held high, the flip-flop would be “set” and when the data is low, the flip-flop would change and become “reset”. The clock may be configured to isolate the data input from the flip-flop's latching circuitry after the desired data has been stored. The effect is that D input condition is only copied to the output Q when the clock input is active. As such, each of the pair of clocked flip-flop circuits 85a, 85b may be configured to store and output whatever logic level is applied to its data terminal so long as the clock input is high. Once the clock input goes low, the “set” and “reset” inputs of the flip-flop are both held at logic level “1” so it will not change state and store whatever data was present on its output before the clock transition occurred. In other words, the output is “latched” at either logic “0” or logic “1”.

It should be appreciated that other flip-flops besides a D-type may be used. For example, in some embodiments, one or both of the clocked flip-flop circuits 85a, 85b may be a clocked SR NAND flip-flop circuit. In other embodiments, one or both of the clocked flip-flop circuits 85a, 85b may be a clocked SR NOR flip-flop circuit. In other embodiments, one or both of the clocked flip-flop circuits 85a, 85b may be a clocked gated flip-flop circuit.

Each of the clocked flip-flop circuits 85a, 85b are electrically coupled to an AND gate 86c. Further, the direction sensitive phase detector 80 includes a pair of switches 86d, 86e, that are electrically coupled to the current sources 84a, 84b, respectively, and electrically coupled to the AND gate 86c on the input side, and to both of the clocked flip-flop circuits 85a, 85b.

Now referring to FIG. 6B, a graphical illustration of the example position sensor assembly 10 of FIG. 1 based on a direction sensitive phase detector 80 is schematically depicted. As illustrated, the operational zone covers more than one turn which is in perfect linear zone without reaching 100% of Vref. As such, the example position sensor assembly 10 of FIG. 1 based on a direction sensitive phase detector 80 operates within its linear range and stays below its maximum possible output, avoiding the saturation region. The operational zone may be the range of physical movement (e.g., rotation) or input values within which the example position sensor assembly 10 of FIG. 1 based on a direction sensitive phase detector 80 is designed to operate. Further, the example position sensor assembly 10 of FIG. 1 based on a direction sensitive phase detector 80 is a multiturn encoder, which may rotate continuously or over several rotations. The perfect linear zone may be a region where the sensor's output signal (voltage or current) is directly and linearly proportional to the input physical position or movement. This ensures accurate and predictable control, represented by the equation Output=Input×Gain.

Accordingly, the example position sensor assembly 10 of FIG. 1 based on a direction sensitive phase detector 80 is illustrated as designed to use the high precision and extended range of a multi-turn sensor while ensuring the sensor never enters the non-linear saturation region near its voltage limits, thereby maintaining measurement accuracy and control integrity.

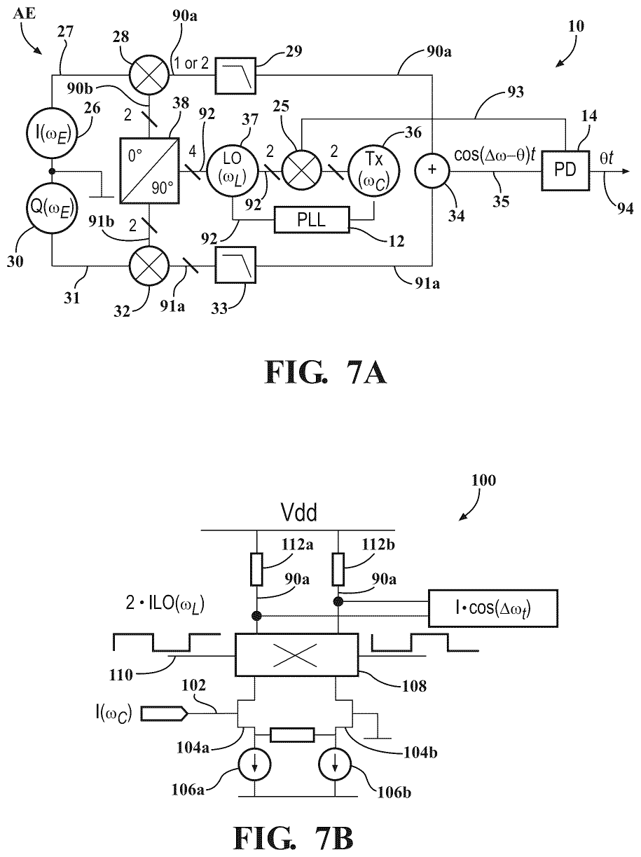

Now referring to FIGS. 7A-7B, which schematically depicts an embodiment of a radio frequency (RF) to base band implementation. In this embodiment, depicted is a signal flow in and the details of mixing function FIG. 7A and an in-phase channel in mixed signals diagram 100 depicted in FIG. 7B, respectively, of an embodiment of the example position sensor assembly 10. In this embodiment, a capacitor-resistor (CR) circuit may be included and/or replaced with a mixer 108 (FIG. 7B) with a different frequency and is configured such that the output frequency can go as low as is desired by controlling the PLL 12. The Δω is the center frequency of the PWM that defines the signal update rate, for example signal around 200 kHz which has max signal bandwidth of 6.5 k RPM of average brushless DC electric motor (BLDC) speed, and can be set by PLL 12. In this way, from low (3 k RPM) to high speed (10 k RPM) of BLDC motor speed can be set.

As illustrated in FIG. 7B, the signal 102, defined as I(ωC), is an input to a transistor 104a which is electrically coupled to a current source 106a and a mixer 108, respectively. The mixer 108 receives a signal 110 defined as 2*ILO(ω_{L}). Further, the in-phase channel in mixed signals diagram 100 depicts the VDD with two supply currents defined as I·cos(Δωt) electrically coupled to the mixer 108, such as the first output signal 90a, which may be an in-phase signal discussed above with respect to FIG. 1. In some embodiments, one, two, or all of the components 112a, 112b, 112c may be a capacitor and resistor circuit. In other embodiments, one, two, or all of the components 112a, 112b, 112c may be a resistor and inductive circuit. In other embodiments, one, two, or all of the components 112a, 112b, 112c may be any combination between a resistor, capacitor, and inductive, as appreciated by those having skill in the art. The mixer 108 is also electrically coupled to a transistor 104b, which is electrically coupled to a current source 106b. The component 112c is positioned to be electrically coupled to both the transistor 104a and the transistor 104b to be in parallel with the mixer 108 and both the transistor 104a and the transistor 104b.

It should be appreciated that the analog components depicted are the mixer 108. All of the signal generators, but the pair of current sources 106a, 106b are digital signals including the local oscillator and capacitor-resistor circuit. As such, the output frequency can go as low as is desired by controlling the PLL 12 (FIG. 7A).

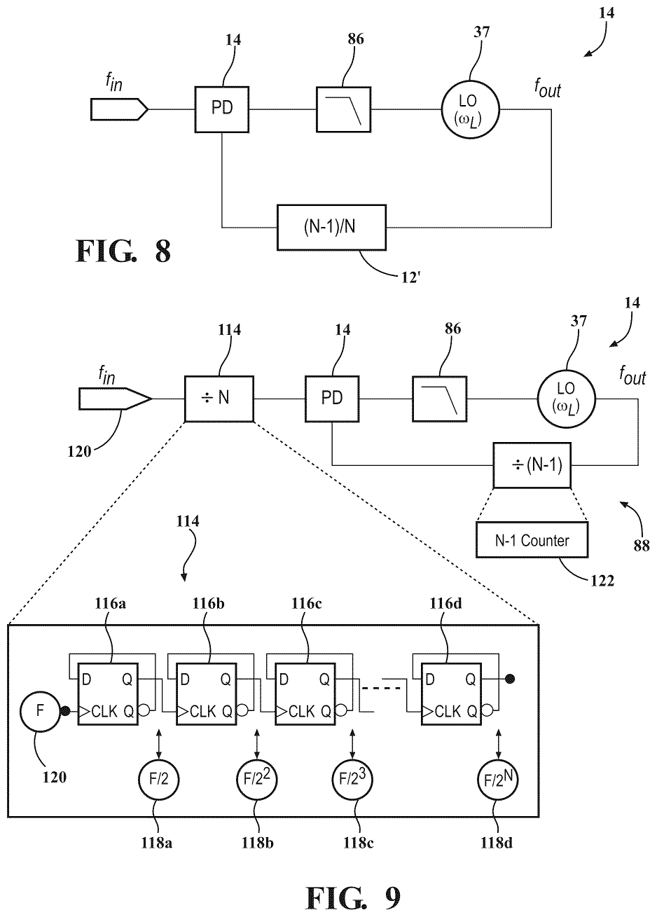

Now referring to FIG. 8, which schematically depicts that an output frequency fₒᵤₜ is equal to N/(N−1), which is the local oscillator 37. The local oscillator 37 translates RF input signal down to lower center frequency for base band management. A low-pass filter 86 may be positioned in series between the phase detector 14 and the local oscillator 37. The PLL 12 may also be an integer N-fractional PLL 12′, which can be generated in various ways such as, without limitation, digital or delta-sigma with digital logics. Following implementation, the N-fractional PLL 12′ for speed matching of a motor may be an all-digital implementation due to the simple management of base band that has no limitation. It should be appreciated that the PLL 12 in FIGS. 1, 5, and 7A described above may be a N-fractional PLL 12′, or may be a different type of PLL such as integer N-fPPL, the fPPL, gPPL, and/or the like. Further, in this embodiment, the N-fractional PLL 12′ (which may also be a delay locked loop (DLL)) is configured such that the local oscillator 37 can be either a current controlled oscillator (ICO) or voltage controlled oscillator (VCO).

Now referring to FIG. 9, which schematically depicts a non-limiting implementation of the n-fractional PLL 12′ of FIG. 8. In the depicted embodiment, the phase detector 14 is either an XOR circuit (digital version of gilbert cell in CMOS) or Analog Gilbert-cell (mixer). The output fₒᵤₜ of the local oscillator 37 has (N−1)/N frequency. Division N circuit 114 is a simple series connection of D-type flip-flops 116a, 116b, 116c, 116d with a frequency divider therebetween 118a, 118b, 118c, 118d to manage the frequency input fᵢₙ 120.

Further, in a divide by N−1 circuit 88, similar frequency dividers are implemented in two ways—a series connection of D-type flip-flop circuits and a counter 122. The arrangement is similar to the division N circuit 114 discussed herein. In a non-limiting example, when there are six D-type flip-flops and a matching six frequency dividers with a division number of 64, in this non-limiting example 63/64 (4 MHz)=123 kHz. and if counter is set to N+1, then there is a 62 kHz center frequency.

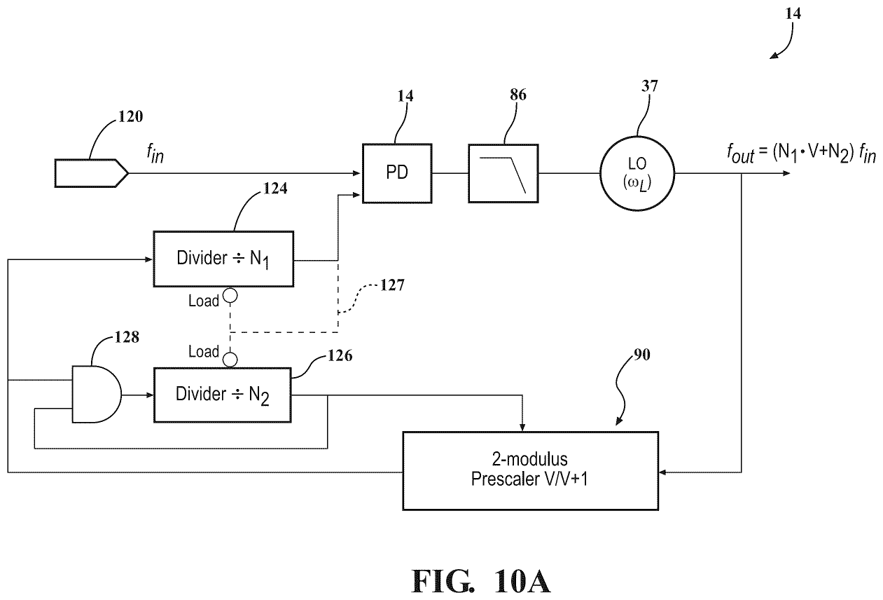

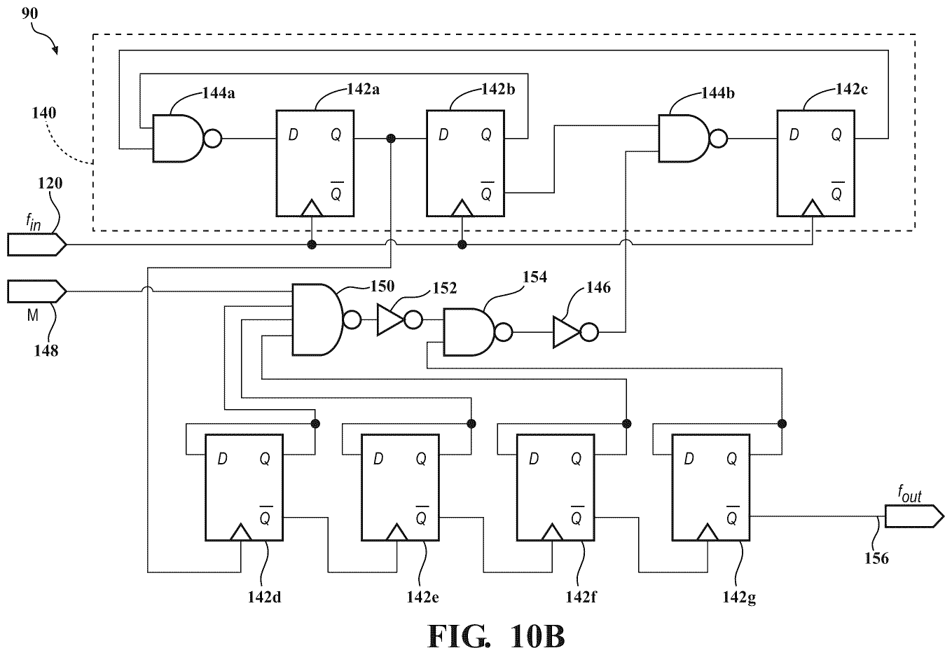

Now referring to FIG. 10A, in another embodiment is a schematic illustration of another non-limiting example of an implementation of the PLL 12 without the counter. As illustrated, this is for the PLL 12 to be between 10 k to 100 k Hz center frequencies, which illustrates the freedom to adjust frequency control in a digital manner. Such an arrangement provides for additional freedom to adjust a frequency control digitally, which is not possible in convention apposition sensor assembly. FIG. 10A illustrates a divider N₁ circuit 124 and a divider N₂ circuit 126, which each receives a load 127 and are each configured to be similar to the Division N circuit 114 of FIG. 9. An AND gate 128 is positioned in series with the divider N₂ circuit 126 such that the output of the AND gate 128 is the input to the divider N₂ circuit 126. A dual-modulus prescaler 90 is configured to receive an output from the divider N₂ circuit 126 and the output fₒᵤₜ from the local oscillator 37. Further, the dual-modulus prescaler 90 is configured to output an input to the AND gate 128 and an input to the divider N₁ circuit 124. The divider N₁ circuit 124 is configured to output to the phase detector 14 as an input to the phase detector along with the frequency input fᵢₙ 120.

FIG. 10B schematically depicts the dual-modulus prescaler 90 architecture of FIG. FIG. 10A. As depicted, the dual-modulus prescaler 90 architecture is a divide by 64/65 dual modulus prescaler. The dual-modulus prescaler 90 architecture may include a counter 140, that may be a divided-by-4 or 5 counter, three D-type clocked flip-flops 142a, 142b, 142c that are each configured to receive the frequency input fᵢₙ 120, and a pair of NAND gates 144a, 144b. The NAND gate 144a is positioned to be one input to the D-type clocked flip-flops 142a and to receive an output from each of the D-type clocked flip-flops 142b, 142c. The NAND gate 144b is configured to be positioned to out to the D-type clocked flip-flops 142c, and to receive an input from the D-type clock flip-flops 142b, and an inverting buffer gate 146. As such, in this arrangement, the D-type clocked flip-flops 142a, 142b are isolated from the D-type clocked flip-flops 142c and form or define a divided-by-4 counter. The divided-by-4 counter is further fed to D-type clocked flip-flops 142d, 142e, 142f, 142g chain of a divided-by-16 divider. The total division ratio is therefore 64.

That is, the dual-modulus prescaler 90 architecture further includes a mode 148 input that is an input into a NAND gate 150 along with an output from each of the D-type clocked flip-flops 142d, 142e, 142f. The NAND gate 150 outputs to an inverter buffer gate 152, which in turn is an input to a NAND gate along with an output of the D-type clocked flip-flop 142g. Further, the D-type clocked flip-flop 142g outputs the fₒᵤₜ frequency 156. The output of the NAND gate 154 is the input to the inverted buffer gate 146 which in turn outputs as the input to the NAND gate 144b, as discussed above.

As such, the dual-modulus prescaler 90 is used in a fractional-N phase-locked loop, in which the mode 148 pin may be controlled by an accumulator, a delta-sigma modulator, and/or the like. By changing the ratio of 0s and 1s on the mode 148, a fractional division number between N and N+1 may be obtained. When the mode 148 is set to ‘0’, the output of the NAND gate 150 may be ‘1’, and thus not influenced by the output of the D-type clocked flip-flops 142a, 142b, 142c chain. As such, the Q pin of the succeeding D-type flip-flop stays at ‘0’. As a result, the first two D-type clocked flip-flops 142a, 142b are isolated from the D-type clocked flip-flops 142c to form the divided-by-4 counter. When the mode 148 is equal to 0, the division ratio is 64, and when the mode 148 is equal to 1, and all other input to the NAND gate 150 is 1, then the division ratio is 65.

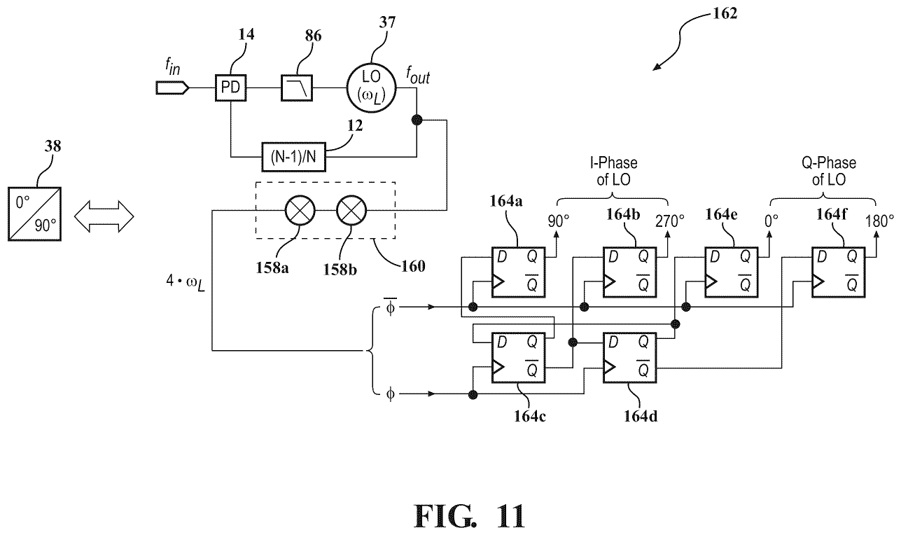

Now referring to FIG. 11, which schematically depicts an example quadrature oscillator implantation architecture. As depicted, for example, when driven by 4 times via 4 XORs logic gates of local oscillator 37 to get the (N−1)/N center frequency of baseband (“BB”), the BB signal may be at a non-integer frequency ratio relative to the local oscillator 37, effectively creating local oscillator frequency with a non-harmonic ratio to avoid problems like local oscillator feedthrough. The pair of frequency modifiers 158a, 158b illustrated in the phantom box 160 may be replaced by a PLL that quadruples the frequency without a band path filter (i.e., frequency multiplier requires a band path filter).

Further illustrated is a 4-phase generator and resynchronizer 162, such as, without limitation, a synchronizer for a 4-pole synchronous generator, a 4-phase electrical system requiring synchronization, and/or the like. The 4-phase generator and resynchronizer 162 includes a plurality of D type clocked flip-flops 164a-164f that are arranged and configured to output the in-phase (I-phase) of the local oscillator and the quadrature phase (Q-phase) of the local oscillator.

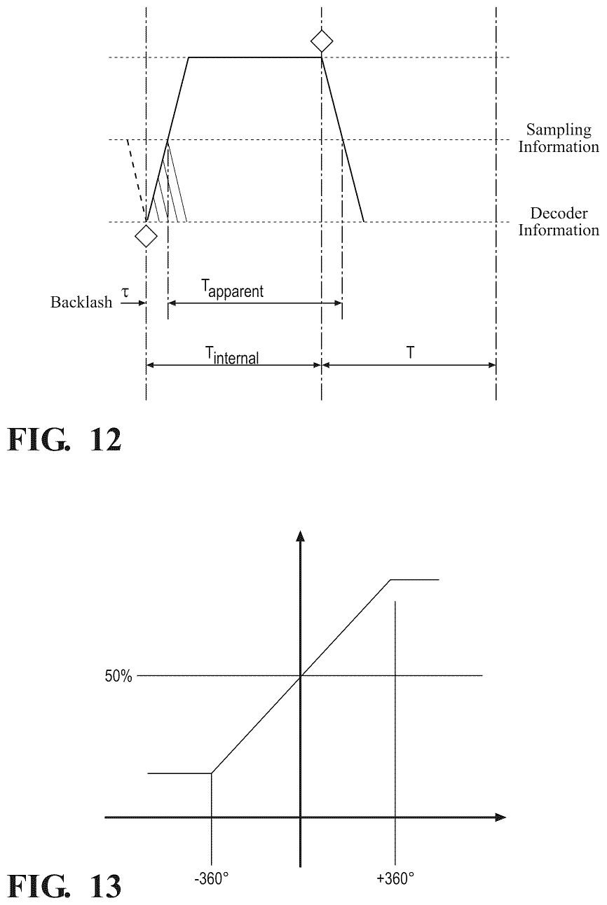

FIG. 12 graphically depicts one embodiment to for the solution to zero duty with limited ramping. As depicted, for 100% duty is acceptable when the ramping up and down slopes are the same as shown because of the second trigger point has the same induced delay. However, for 0% duty instances, an error is introduced because the assembly cannot reach the sampling band. This is similar to a back-lash problem of mechanical measuring device. In an internal phase error, the accuracy of the example position sensor assembly 10 internal is the same level accuracy of a typical PLL, when ATAN output has negligible error. In external phase error, (e.g., backlash z), the limitation of the ramping due to EMC limits zero measuring until certain duty, T, which needs to reduce. However, as illustrated, in this arrangement of the example position sensor assembly 10, the back-lash r never reaches the sampling band (sampling information). As such, the error may be reduced by increasing ramping to a smaller voltage by using a differential wire, as shown in FIG. 1.

FIG. 13 graphically depicts one embodiment for the solutions to backlash. As depicted, the output will be removed from PD and buffered it as in FIG. 1. This eliminates back-lashes in both ends. Further, the signal zero is at Vdd/2, and the positive position at 90% and the negative position at 10% in either analog or PWM in differential mode as in PD output in normal PLL 12.

Thus, disclosed is a rotary position sensor assembly that has a structural arrangement for detecting not only a position of the sensor, but also provides data with respect to a direct output of angle and a speed of a rotor of a motor. In other words, the present rotary position sensor assembly produces desirable data that is not possible with conventional sensor assemblies and does so with a smaller form factor and a less power consumption implementation compared to conventional position sensor assemblies. Further, the rotary position sensor assembly described herein may be used in both low speed and high speed applications. As such, the example position sensor assembly described herein is configured to meet current technical desires of high power density, high efficiency requirements, high speed data transmission, and reduction of magnetic noise and environmental contaminations without DSP or RDC support.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A motor position sensor comprising:
a first receiver coil electrically coupled to a first multiplier to generate a first output;
a second receiver coil electrically coupled to a second multiplier to generate a second output;
a transmitter coil electrically coupled to an oscillator, the oscillator electrically coupled to a third multiplier to generate a third output;
a phase-locked loop electrically coupled to the oscillator and the transmitter coil;
a summing circuit configured to receive the first output and the second output and configured to generate a signal;
a phase detector positioned in series with the summing circuit and configured to receive the signal and the third output, the phase detector outputting a sense signal that is indicative of an angle of the motor position sensor; and
a pair of (operational amplifiers) op amps electrically coupled to the phase detector, one op amp of the pair of op amps configured to output an analog differential signal and the other one op amp of the pair of amp amps configured to output a differential phase signal.

2. The motor position sensor of claim 1, wherein the output of the analog differential signal and the output of the differential phase signal defines a ratio of two channel amplitudes.

3. The motor position sensor of claim 2, wherein the ratio of the two channel amplitudes is an arctangent of the angle of the motor position sensor.

4. The motor position sensor of claim 1, further comprising:
a counter configured to receive the sense signal,
wherein the counter is configured to output, based on the sense signal, a speed of counter signal.

5. The motor position sensor of claim 4, wherein the speed of counter signal and the analog differential signal are compressed into a single angle phase signal and output as an angle decoder signal.

6. The motor position sensor of claim 5, wherein a resolution is determined by the phase-locked loop and the speed of the counter signal.

7. The motor position sensor of claim 1, wherein the phase-locked loop is configured as a fractional phase-locked loop.

8. The motor position sensor of claim 1, wherein the signal generated by the summing circuit is a cosine function cos (Δω−θ)t where t is time, and a difference between two phase terms Δω is a change in an angular frequency or a frequency difference and θ is a phase shift affecting the overall oscillation.

9. The motor position sensor of claim 8, wherein the third output generated by the third multiplier is a sinusoidal oscillation function cos Δωt where t is time, Δ is a change or variation in the angular frequency ω.

10. The motor position sensor of claim 4, further comprising:
a frequency multiplier electrically coupled to the first multiplier, the second multiplier, and the oscillator, the frequency multiplier configured to offset the angular frequency by 90 degrees.

11. The motor position sensor of claim 1, wherein the sense signal is an angle encoder signal that includes both a position and a speed of rotation.

12. A rotary position sensor comprising:
a first receiver coil electrically coupled to a first multiplier to generate a first output;
a second receiver coil electrically coupled to a second multiplier to generate a second output;
a transmitter coil electrically coupled to an oscillator, the oscillator electrically coupled to a third multiplier to generate a third output;
a phase-locked loop electrically coupled to the oscillator and the transmitter coil;
a summing circuit configured to receive the first output and the second output and configured to generate a signal;
a phase detector positioned in series with the summing circuit and configured to receive the signal and the third output, the phase detector outputting a sense signal that is indicative of an angle of the motor position sensor;
a counter configured to receive the sense signal and output, based on the sense signal, a speed of counter signal; and
a pair of (operational amplifiers) op amps electrically coupled to the phase detector, one op amp of the pair of op amps configured to output an analog differential signal and the other one op amp of the pair of amp amps configured to output a differential phase signal,
wherein the output of the analog differential signal and the output of the differential phase signal defines a ratio of two channel amplitudes.

13. The rotary position sensor of claim 12, wherein the ratio of the two channel amplitudes is an arctangent of the angle of the motor position sensor.

14. The rotary position sensor of claim 12, wherein the speed of counter signal and the analog differential signal are compressed into a single angle phase signal and output as an angle decoder signal.

15. The rotary position sensor of claim 14, wherein a resolution is determined by the phase-locked loop and the speed of the counter signal.

16. The rotary position sensor of claim 12, wherein the phase-locked loop is configured as a fractional phase-locked loop.

17. The rotary position sensor of claim 12, wherein the signal generated by the summing circuit is a cosine function cos (Δω−θ)t where t is time, and a difference between two phase terms Δω is a change in an angular frequency or a frequency difference and θ is a phase shift affecting the overall oscillation.

18. The rotary position sensor of claim 17, wherein the third output generated by the third multiplier is a sinusoidal oscillation function cos Δωt where t is time, Δ is a change or variation in the angular frequency ω.

19. The rotary position sensor of claim 12, further comprising:
a frequency multiplier electrically coupled to the first multiplier, the second multiplier, and the oscillator, the frequency multiplier configured to offset the angular frequency by 90 degrees.

20. The rotary position sensor of claim 12, wherein the sense signal is an angle encoder signal that includes both a position and a speed of rotation.
